(19) United States
(12) Patent Application Publication
(10) Pub. No.: US 2009/0102380 A1
(43) Pub. Date: Apr. 23, 2009

(54) PLASMA DISPLAY PANEL AND MANUFACTURING METHOD OF THE SAME

(75) Inventor: Masahiro Watabe, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/188,007

(22) Filed: Aug. 7, 2008

(30) Foreign Application Priority Data
Oct. 18, 2007 (JP) 2007-271021

(51) Int. Cl. H01J 9/26; H01J 17/49

(52) U.S. Cl. 313/582; 445/25

(57) ABSTRACT

The present invention improves a manufacturing efficiency of a plasma display panel. In a plasma display panel (PDP) having a front structure (first structure) and a rear structure (second structure) which are disposed so as to be opposed to each other, the front structure and the rear structure are sealed with vacuum grease (sealing material) which is disposed so as to surround a plurality of barrier ribs formed on one surface of the rear structure and has a gas barrier characteristic, and they are fixed to each other with an adhesive agent which is disposed on an outer side of the vacuum grease with respect to the barrier ribs and has a lower viscosity than the vacuum grease.

### CROSS-REFERENCE TO RELATED APPLICATION

The present application claims priority from Japanese Patent Application No. JP 2007-271021 filed on Oct. 18, 2007, the content of which is hereby incorporated by reference into this application.

### TECHNICAL FIELD OF THE INVENTION

The present invention relates to a technology for a plasma display. More particularly, it relates to a technology effectively applied to a plasma display panel in which a peripheral portion of a pair of substrates is sealed in a state where these substrates are opposed to each other.

### BACKGROUND OF THE INVENTION

A plasma display panel (PDP) is a display panel in which a gas discharge is generated in a discharge space called a cell filled with a discharge gas such as a rare gas and phosphors are excited by vacuum ultraviolet rays generated at the time of this discharge, thereby displaying an image.

In general, the PDP has a structure in which a pair of substrates is laminated in a state of being opposed to each other. Discharge electrodes and a dielectric layer that covers the discharge electrodes are formed on an opposing surface side of one of these substrates (front substrate). Also, a protective layer for protecting the dielectric layer from collision (sputter) of ions generated by electrolytic dissociation by plasma is formed on a surface of the dielectric layer.

When electrons and ions generated by electrolytic dissociation collide with this protective layer, secondary electrons are emitted from the protective layer. By increasing a secondary electron emission coefficient of the protective layer, the firing voltage can be reduced. In other words, power consumption at the time of driving the PDP can be reduced. Therefore, metal oxide such as MgO (magnesium oxide) with a secondary electron emission coefficient higher than that of the dielectric layer is generally used for the protective layer.

Further, address electrodes and barrier ribs for partitioning the space on the substrate into predetermined discharge spaces are formed on an opposing surface side of the other substrate (rear substrate).

In the PDP, the discharge spaces are formed by laminating the front substrate and the rear substrate in a state of being opposed to each other, and a predetermined discharge gas is filled therein. Further, in order to fix both the substrates while shutting off an air flow between an inner side of the discharge space and an outside of the PDP, a peripheral portion of a region in which the front substrate and the rear substrate are laminated is fixed with an adhesive agent.

As the adhesive agent, a low-melting point glass material called frit glass is generally used. Further, for example, Japanese Patent Application Laid-Open Publication No. 10-27552 (Patent Document 1) discloses a PDP with a structure in which a thermoplastic resin is used as the adhesive agent and vacuum grease is applied to an outer surface of the thermoplastic resin.

### SUMMARY OF THE INVENTION

In the case where the frit glass is used for the adhesive agent between the front substrate and the rear substrate of the PDP, since a softening point of the frit glass is as high as 400° C. or more, it takes a long time to heat up to the softening point, and the number of PDPs which can be processed per unit time is reduced. Further, the lead time of a step of fixing the front substrate and the rear substrate has to be increased. Accordingly, there arises a problem that a manufacturing efficiency of the PDP is lowered.

In order to increase the number of PDPs which can be processed per unit time, it is necessary to enlarge the size of a manufacturing apparatus. Accordingly, there arises a problem that an initial cost and a running cost of the manufacturing apparatus are increased.

Incidentally, the metal oxide used for the protective layer of the PDP has a property of easily adsorbing moisture in the air. If the moisture is adsorbed in the metal oxide, the metal oxide reacts with water to be deliquesced or transformed to a metal hydroxide compound. This metal hydroxide compound is significantly inferior to metal oxides in sputter resistance and secondary electron emission coefficient. Therefore, the crystal structure of the protective layer tends to be destroyed by sputter. Also, it becomes disadvantageously impossible to reduce a firing voltage.

To get around these problems, there is a method in which the process of forming a protective layer on a surface of a dielectric layer of a front substrate and then laminating and fixing both the substrates with an adhesive agent is performed in a vacuum (reduced pressure atmosphere), thereby suppressing the moisture adsorption.

However, since the discharge electrodes and the address electrodes have to be disposed with a predetermined positional relation when laminating the front substrate and the rear substrate, the highly accurate alignment is required. When the alignment is performed in vacuum, it is inevitable that the manufacturing apparatus has a complicated mechanism. If the manufacturing apparatus has a complicated mechanism, the manufacturing apparatus is enlarged in size.

Further, since the possibility of dust generation becomes higher when the manufacturing apparatus having the complicated mechanism is operated, a predetermined degree of vacuum cannot be maintained in some cases. Further, a foreign material gets into the PDP depending on the degree of the dust generation, and the reliability of the PDP is adversely affected in some cases.

The present invention has been made in consideration of the problems mentioned above, and an object of the present invention is to provide a technology capable of improving a manufacturing efficiency of the PDP.

The typical ones of the inventions disclosed in this application will be briefly described as follows.

More specifically, the present invention provides a plasma display panel comprising a first structure and a second structure disposed so as to be opposed to each other, wherein the first structure and the second structure are sealed with a sealing material which is disposed so as to surround a plurality of barrier ribs formed on one surface of the second structure and has a gas barrier characteristic, and the first structure and the second structure are fixed with an adhesive agent which is disposed on an outer side of the sealing material with respect to the barrier ribs and has lower viscosity than the sealing material.

The effects obtained by typical aspects of the present invention will be briefly described below. That is, it is possible to reduce the power consumption when driving the PDP.

### BRIEF DESCRIPTIONS OF THE DRAWINGS

These and other features, objects and advantages of the present invention will become more apparent from the following description when taken in conjunction with the accompanying drawings wherein:

FIG. 1 is an enlarged perspective view showing the principal part of a PDP according to the first embodiment of the present invention in an enlarged manner;

FIG. 2 is an enlarged cross sectional view showing the principal part of the structure of an end portion of a front structure and a rear structure in a state where the front structure and the rear structure shown in FIG. 1 are laminated;

FIG. 3 is a plan view showing the front structure of the PDP according to the first embodiment of the present invention in a transparent manner;

FIG. 4 is an enlarged perspective view showing the principal part of a structure of a front structure prepared in advance in a manufacturing method of a PDP according to the first embodiment of the present invention;

FIG. 5 is an enlarged perspective view showing the principal part of a structure of a rear structure prepared in advance in the manufacturing method of the PDP according to the first embodiment of the present invention;

FIG. 6 is an enlarged perspective view showing the principal part in a state where a protective layer is formed on the front structure shown in FIG. 4;

FIG. 7 is an enlarged cross sectional view showing the principal part of a structure of a peripheral portion of a panel structure in which the front structure and the rear structure are combined, in the manufacturing method of the PDP according to the first embodiment of the present invention;

FIG. 8 is a plan view of a PDP apparatus according to a second embodiment of the present invention seen from a display surface side;

FIG. 9 is a plan view of the PDP apparatus shown in FIG. 8 seen from a surface opposite to the display surface (rear surface side);

FIG. 10 is a plan view showing a state where a front frame cover (outer casing) is detached from the PDP apparatus shown in FIG. 8;

FIG. 11 is a plan view showing a state where a rear cover (outer casing) is detached from the PDP apparatus shown in FIG. 8; and

FIG. 12 is an enlarged cross sectional view showing the principal part of a structure of a peripheral portion of a panel structure in which the front structure and the rear structure are combined, in a manufacturing method of a PDP according to a first modified embodiment of the first embodiment of the present invention.

### DESCRIPTIONS OF THE PREFERRED EMBODIMENTS

Components having the same function are denoted by the same reference numbers throughout the drawings for describing the embodiments, and the repetitive description thereof will be omitted. Hereinafter, embodiments of the present invention will be described in detail with reference to the accompanying drawings.

### First Embodiment

<Structure of PDP>

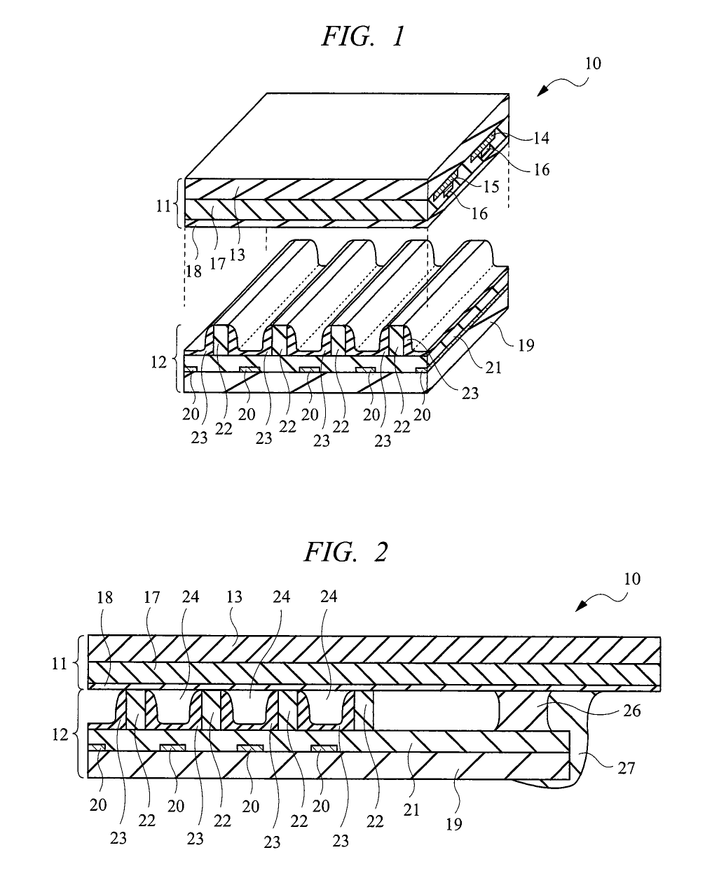

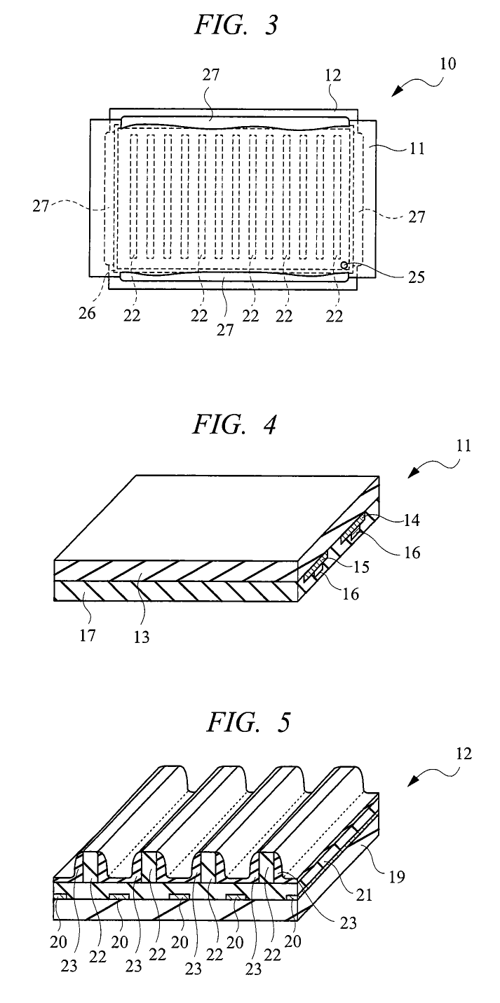

First, the structure of a PDP according to a first embodiment will be described with reference to FIGS. 1 to 3, in which an alternating-current surface discharge type PDP is used as an example. FIG. 1 is an enlarged perspective view showing the principal part of the PDP according to the first embodiment in an enlarged manner, FIG. 2 is an enlarged cross sectional view showing the principal part of the structure of an end portion of a front structure and a rear structure in a state where the front structure and the rear structure shown in FIG. 1 are laminated, and FIG. 3 is a plan view showing the front structure of the PDP in which the front structure and the rear structure are laminated in a transparent manner. Note that, for easy description of the structure of the PDP, FIG. 1 shows the state where the front structure and the rear structure are away from each other more than a predetermined space.

In FIG. 1, a PDP 10 has a front structure (first structure) 11 and a rear structure (second structure) 12. The front structure 11 and the rear structure 12 are combined together in a state of being opposed to each other.

The front structure 11 has a display surface of the PDP 10 and has a front substrate (first substrate) 13 mainly made of glass on a display surface side. On a surface of the front substrate 13 opposite to the display surface, a plurality of X electrodes (first electrodes) 14 and Y electrodes (first electrodes) 15 for performing sustain discharge are formed. Since these X electrodes 14 and Y electrodes 15 are formed on the display surface side of the PDP 10, they are made of a transparent electrode material.

The X electrodes 14 and Y electrodes 15 are formed so as to extend along a lateral (row) direction. Also, the X electrodes 14 and Y electrodes 15 are alternately disposed at a predetermined interval in a longitudinal (column) direction that crosses their extending direction. Also, each of the X electrodes 14 and each of the Y electrodes 15 are disposed so as to be parallel to each other. In the PDP 10, a pair of one X electrode 14 and one Y electrode 15 forms a display row.

Also, a bus electrode 16 is formed on each of the X electrodes 14 and the Y electrode 15. For the reduction of electrical resistance of the X electrode 14 and the Y electrode 15, the bus electrode 16 is made of a metal material.

These electrodes (X electrodes 14, Y electrodes 15 and bus electrodes 16) are covered with a dielectric layer (first dielectric layer) 17. The dielectric layer 17 is made of, for example, a material called a low-melting point glass mainly containing lead oxide and is formed to have a thickness of 25 μm.

Further, a protective layer (metal oxide layer) 18 made of metal oxide such as MgO is formed on a surface of the dielectric layer 17. The protective layer 18 is formed so as to cover one surface of the dielectric layer 17.

The material used for the protective layer 18 is not limited to a single component of MgO. For example, it is possible to use a composite material obtained by mixing CaO (calcium oxide) with MgO. A sputter resistance of the protective layer 18 can be improved by mixing CaO.

On the other hand, the rear structure 12 has a rear substrate (second substrate) 19 mainly made of glass. On the rear substrate 19, a plurality of address electrodes (second electrodes) 20 are formed. Each of the address electrodes 20 is formed so as to extend in a longitudinal (column) direction that crosses (at approximately a right angle) the direction in which the X electrodes 14 and the Y electrodes 15 extend. Also, the address electrodes 20 are disposed at a predetermined interval so as to be parallel to each other.

The address electrodes 20 are covered with a dielectric layer (second dielectric layer) 21. On the dielectric layer 21, a plurality of barrier ribs 22 extending in a thickness direction of the rear structure 12 are formed. The barrier ribs 22 are formed so as to extend in a linear shape along a direction in which the address electrodes 20 extend. Also, the planar position of each barrier rib 22 is located between adjacent address electrodes 20. By disposing each barrier rib 22 between the adjacent address electrodes 20, spaces to partition the surface of the dielectric layer 21 in a column direction are formed so as to correspond to the positions of the address electrodes.

Furthermore, an upper surface of the dielectric layer 21 on each address electrode 20 and side surfaces of each barrier rib 22 are coated with phosphors 23 that are excited by ultraviolet rays to emit the red (R), green (G) and blue (B) visible lights.

In the PDP 10, one cell is configured so as to correspond to an intersection of one pair of the X electrode 14 and the Y electrode 15 and the address electrode 20. Also, a set of the R, G and B cells forms a pixel.

Next, as shown in FIG. 2, the front structure 11 and the rear structure 12 are fixed in a state where the surface on which the protective layer 18 is formed and the surface on which the barrier ribs 22 are formed are opposed to each other. The protective layer 18 and the barrier ribs 22 are fixed in a state of being in at least partial contact with each other. A distance between the front structure 11 and the rear structure 12 is defined by the barrier rib 22, and the distance is, for example, about 100 μm to 200 μm.

Since the protective layer 18 and the barrier rib 22 are fixed in a contact state, the discharge spaces 24 partitioned by the protective layer 18 and the barrier ribs 22 are formed, and the phosphors 23 are applied to the surfaces (bottom surface and both side surfaces) of the discharge spaces 24 on the rear structure 12 side. The discharge space 24 is filled with a gas called a discharge gas (for example, mixed gas of Ne and Xe) at a predetermined pressure.

The PDP 10 generates a discharge for each cell in the discharge space 24 to excite the phosphors 23 of R, G and B by vacuum ultraviolet rays generated by the discharge, thereby emitting light.

Further, as shown in FIG. 3, the lengths of outer margins of the front structure 11 and the rear structure 12 forming the PDP 10 are different from each other, and the front structure 11 and the rear structure 12 are laminated in a state where one of them partly protrudes from the other. This is for the purpose of forming electrode terminals of the respective electrode groups of the address electrodes 20 (refer to FIG. 1), the X electrodes 14 (refer to FIG. 1) and the Y electrodes 15 (refer to FIG. 1) included in the PDP 10 in this protruding portion, thereby facilitating an electrical connection to each of the circuits connected to the PDP 10.

Note that, although the number of the barrier ribs 22 is set to thirteen for easily understanding a whole structure of the PDP 10 in FIG. 3, the number of the barrier ribs 22 is larger than this, and a lot of barrier ribs 22 are formed in accordance with the definition of the PDP 10.

Further, at a corner portion of a region where the front structure 11 and the rear structure 12 are laminated in a state of being opposed to each other, a chip tube (ventilation member) 25 used as a ventilation hole of the discharge space 24 in a manufacturing stage of the PDP 10 is disposed with its opening being sealed. The use of the chip tube 25 will be described in detail in the following description of the manufacturing method of the PDP 10.

In this case, a peripheral portion of the PDP 10 (peripheral portion of the region in which the front structure 11 and the rear structure 12 are laminated) is sealed with vacuum grease (sealing material) 26. The vacuum grease 26 is applied so as to surround the periphery of the barrier ribs 22 as shown in FIG. 3. The vacuum grease 26 is a material used as a seal material for a vacuum case or the like, and has the following characteristics.

First, the vacuum grease 26 has a gas barrier characteristic and prevents the passage of a component gas (for example, a hydrogen molecule or a water molecule) in the atmospheric air. Secondly, the vacuum grease 26 has a characteristic of preventing or suppressing a gas emission from the inner side through the vacuum grease 26 even in a vacuum (reduced pressure) atmosphere of, for example, about 1×10⁻⁴ Pa. Thirdly, the vacuum grease 26 has an adhesion with a non-seal member (front structure 11 and rear structure 12 in the first embodiment) and is not peeled off easily. Fourthly, the vacuum grease 26 has a viscosity, and therefore, the front structure 11 and the rear structure 12 can move while maintaining the close contact state in place of completely fixing the front structure 11 and the rear structure 12. Fifthly, the vacuum grease 26 has an electrically insulating property.

As the vacuum grease having the characteristics mentioned above, for example, there are silicone grease, fluoroether grease, fluorine grease, grease consisting primarily of carbon hydride, and the like.

In the PDP 10, the gas flow between the discharge space 24 and the outside of the PDP 10 is shut off by sealing the peripheral portion of the region in which the front structure 11 and the rear structure 12 are laminated, with the vacuum grease 26 disposed so as to surround the periphery of the barrier ribs 22.

Further, an adhesive agent 27 is disposed on an outer side of the vacuum grease 26 with respect to the barrier rib 22, so that the front structure 11 and the rear structure 12 are fixed to have a predetermined positional relation. A material having a lower viscosity than the vacuum grease 26 is used for the adhesive agent 27 because it is necessary to maintain (fix) the front structure 11 and the rear structure 12 with the predetermined positional relation.

However, since the PDP 10 is sealed with the vacuum grease 26, the gas barrier characteristic is not required for the adhesive agent 27 disposed outside the vacuum grease 26. It is desirable that a material which can fix the front structure 11 and the rear structure 12 and can maintain the binding force at a temperature in lighting the panel (100° C. or less) is used for the adhesive agent 27. Accordingly, any arbitrary material (for example, a thermosetting resin, a silicone resin, a silicone rubber, an epoxy resin or the like) which can fix the front structure 11 and the rear structure 12 with the predetermined positional relation can be selected as the adhesive agent 27.

Even in the case where a material having no gas barrier characteristic is selected for the adhesive agent 27, the sealed state of the discharge space 24 can be secured only by the vacuum grease 26.

Further, the adhesive agent 27 is disposed so as to cover a part of an end portion of either the front structure 11 or the rear structure 12. Since FIG. 2 is an enlarged view of the region in which the end portion of the front structure 11 protrudes from the end portion of the rear structure 12, the adhesive agent 27 is disposed so as to cover the end portion of the rear structure 12. However, in the region in which the end portion of the rear structure 12 protrudes from the end portion of the front structure 11 as shown in FIG. 3, the adhesive agent 27 is disposed so as to cover the end portion of the front structure 11.

By disposing the adhesive agent 27 so as to cover a part of the end portion of either the front structure 11 or the rear structure 12, the adhesive strength of the adhesive agent 27 can be improved. Accordingly, it is possible to firmly fix the front structure 11 and the rear structure 12.

The other effects obtained by using the structure of the PDP 10 mentioned above will be described in detail in the following description of the manufacturing method of the PDP 10.

Meanwhile, the PDP 10 can take various structures depending on required performance and driving method thereof, and the structure of the PDP 10 according to the first embodiment is not limited to that shown in FIG. 1 and FIG. 2. By way of example, FIG. 1 shows an example in which the discharge space is partitioned by the barrier ribs 22 extending in a linear shape (vertical direction).

However, for the purpose of increasing luminance or others, the discharge space may be partitioned by barrier ribs disposed in a lattice shape. The PDP 10 according to the first embodiment can take such a structure.

<Manufacturing Method of PDP>

Next, the manufacturing method of the PDP 10 according to the first embodiment will be described with reference to FIG. 1 to FIG. 7. FIG. 4 is an enlarged perspective view showing the principal parts of the structure of the front structure prepared in advance in the manufacturing method of a PDP according to the first embodiment. FIG. 5 is an enlarged perspective view showing the principal parts of the structure of the rear structure prepared in advance in the manufacturing method of a PDP according to the first embodiment.

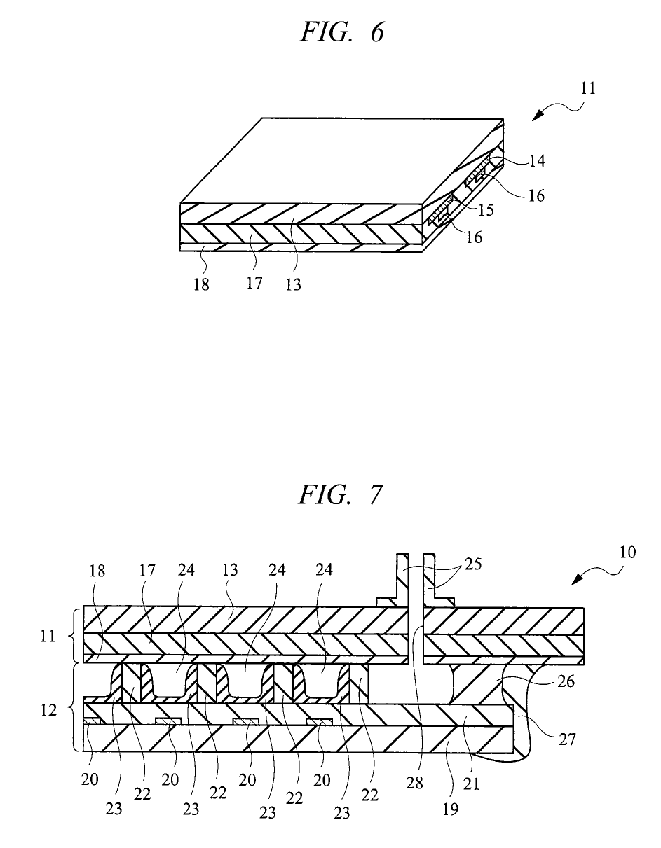

FIG. 6 is an enlarged perspective view showing the principal parts in the state where the protective layer is formed on the front structure shown in FIG. 4. FIG. 7 is an enlarged cross-sectional view showing the principal parts of the structure of a peripheral portion of a panel structure obtained by assembling the front structure and the rear structure in the manufacturing method of a PDP according to the first embodiment.

(a) First, the front structure (first structure) 11 shown in FIG. 4 is prepared. The front structure 11 shown in FIG. 4 is fabricated in advance in the following manner.

First, the front substrate 13 is prepared, and the X electrodes 14 and the Y electrodes 15 are formed with a predetermined pattern on one surface of the front substrate 13. Also, the bus electrode 16 is formed on each of the X electrodes 14 and the Y electrodes 15. Next, the dielectric layer 17 is formed on the front substrate 13 so as to cover the X electrodes 14, the Y electrodes 15 and the bus electrodes 16. At this stage, the protective layer 18 shown in FIG. 1 is not yet formed on the front structure 11.

Also, the rear structure (second structure) 12 shown in FIG. 5 is prepared. The rear structure 12 shown in FIG. 5 is fabricated in advance in the following manner.

First, the rear substrate 19 is prepared, and the address electrodes 20 are formed with a predetermined pattern on one surface of the rear substrate 19. Next, the dielectric layer 21 is formed on the surface of the rear substrate 19 so as to cover the address electrodes 20. Then, the barrier ribs 22 defining the discharge spaces are formed on the surface of the dielectric layer 21. The barrier ribs 22 are formed so as to extend along the address electrodes 20.

Note that it is not always necessary to provide the rear structure 12 at this stage, and it does not cause any problem if the rear structure 12 is provided at least before an assembling step (c) described further below.

(b) Next, as a protective layer forming step, the protective layer 18 shown in FIG. 6 is formed on the surface of the dielectric layer 17 of the front structure 11. The protective layer 18 is made of, for example, MgO and can be formed by, for example, vapor deposition. In the first embodiment, the protective layer 18 made of MgO and having a thickness of 1 μm is formed on the surface of the dielectric layer 17 by a vacuum deposition method with electron beams using an MgO source as a target.

In this case, metal oxide such as MgO constituting the protective layer 18 has a property of easily adsorbing the moisture in the air. Accordingly, the protective layer forming step is carried out in the vacuum (reduced pressure) atmosphere so as to prevent or suppress the moisture from attaching to the protective layer 18.

The front structure 11 on which the protective layer 18 has been formed is temporarily cooled by the conveyance to the next step (assembling step). If the front structure 11 is exposed to the atmospheric air during the conveyance to the next step, the protective layer 18 adsorbs the moisture or the like in the atmospheric air. Therefore, a heat treatment is necessary for desorbing an impurity such as the moisture adsorbed by the protective layer 18 in the next step (for example, held for several hours at a temperature of about 400° C.).

Therefore, in the first embodiment, the front structure 11 is conveyed under the vacuum atmosphere even in the conveyance to the next step. Since it is possible to prevent the contamination of the protective layer 18 (adsorption of impurity) by conveying the front structure 11 under the vacuum atmosphere and then assembling, the heating step for the purpose of desorbing the impurity from the protective layer 18 can be omitted.

(c) Next, the PDP 10 shown in FIG. 1 is assembled. The assembly of the rear structure 12 shown in FIG. 5 and the front structure 11 shown in FIG. 6 is carried out in the following manner.

(c1) First, as a sealing step, in a state where the surface of the front structure 11 on which the protective layer 18 is formed as shown in FIG. 2 and the surface of the rear structure 12 on which the barrier ribs 22 are formed are opposed to each other, the front structure 11 and the rear structure 12 are laminated, and the peripheral portion of the region in which the front structure 11 and the rear structure 12 are laminated is sealed.

In this sealing step, the front structure 11 and the rear structure 12 are sealed while roughly aligning the positions thereof. However, the highly accurate alignment is not required in this stage.

When disposing the vacuum grease 26, for example, it is possible to use a method of applying the vacuum grease 26 to a predetermined position shown in FIG. 3 so as to surround the periphery of the barrier ribs 22. The vacuum grease 26 is softer than a frit glass (low-melting point glass) paste which is generally used as the sealing material. Accordingly, it is also possible to use a method of providing the vacuum grease 26 so as to fill the gap between both the structures after laminating the front structure 11 and the rear structure 12.

In the first embodiment, since the vacuum grease 26 is used as the sealing material, it is not necessary to heat the PDP 10 for sealing. In other words, since the step of heating the PDP 10 can be omitted in the sealing step according to the first embodiment, it is possible to significantly shorten the processing time of the sealing step.

Accordingly, it is possible to significantly improve the manufacturing efficiency in comparison with the case where the frit glass, the thermoplastic resin or the like is used as the sealing material. Further, it is possible to significantly reduce the consumed energy during the manufacturing process.

Further, since a buffer space of the manufacturing apparatus can be made small by shortening the processing time of the sealing step, the manufacturing apparatus can be downsized.

The vacuum grease 26 is in a close contact with each of the front structure 11 and the rear structure 12 and seals the peripheral portion of both the structures. As a result, the discharge space 24 shown in FIG. 2 is shut off from the outside of the PDP 10.

Accordingly, the process up to the sealing step is carried out under the vacuum (reduced pressure) atmosphere for preventing the phenomenon that the protective layer 18 adsorbs an impurity such as moisture or the like. However, the PDP 10 can be exposed to the atmospheric air after the sealing step is finished.

Note that a hole portion (through hole) 28 penetrating through the front structure 11 or the rear structure 12 is formed at at least one or more positions inside the region sealed with the vacuum grease 26 as shown in FIG. 7 (FIG. 7 shows an example in which the hole portion 28 is formed in the front structure 11).

Also, a tip tube (ventilating means) 25 such as a glass tube is fixed in alignment with this hole portion 28. At the stage of the end of the sealing step, the tip tube 25 is in an open state. The discharge space 24 is not completely shut off from the outside of the PDP 10, but ventilation from and to the outside of the PDP 10 (gas intake from outside or gas exhaust to outside) is possible through this tip tube 25.

(c2) Next, as an alignment step, the front structure 11 and the rear structure 12 are aligned so as to have a predetermined positional relation. In the alignment step, a highly accurate adjustment is made so that the X electrodes 14 (refer to FIG. 4) and the Y electrodes 15 (refer to FIG. 4) of the front structure 11 and the address electrodes 20 of the rear structure 12 have the predetermined positional relation.

In this stage, the front structure 11 and the rear structure 12 constituting the PDP 10 are already sealed. Accordingly, for example, even if the steps subsequent to this step are performed in the ambient atmosphere, the adsorption of the impurity of the protective layer 18 can be prevented or suppressed. Further, in the case where the steps subsequent to this step are performed in the vacuum (reduced pressure) atmosphere, the adsorption of the impurity of the protective layer 18 can be prevented more surely.

In the case where the frit glass is used as the sealing material between the front structure 11 and the rear structure 12, since the frit glass has been already hardened in the stage where the sealing step is finished, it is impossible to perform the alignment thereof. Therefore, it is necessary to perform the alignment step before the sealing step.

Accordingly, it is necessary to perform the alignment step in the vacuum (reduced pressure) atmosphere. In the case where the alignment step is performed in the vacuum (reduced pressure) atmosphere, the work becomes complicated, and thus, a long time is required for the alignment. Further, since a complicated mechanism is necessary, the manufacturing apparatus is enlarged in size.

However, the vacuum grease 26 is used as the sealing material in the first embodiment. The vacuum grease 26 has the viscosity as mentioned above, and the front structure 11 and the rear structure 12 can move while maintaining the close contact state in place of completely fixing the front structure 11 and the rear structure 12. Accordingly, it is possible to perform the alignment step after the sealing step.

Therefore, according to the first embodiment, since the alignment step can be performed under the ambient atmosphere, the time necessary for the alignment can be shortened, and the manufacturing efficiency can be improved. Further, since the vacuum chamber is not necessary in the steps after the alignment step, the manufacturing apparatus can be downsized.

(c3) Next, as the fixing step, the front structure 11 and the rear structure 12 are fixed. In the fixing step, the adhesive agent 27 is disposed on an outer side of the vacuum grease 26 with respect to the barrier rib 22 (that is, outside the region sealed with the vacuum grease 26) so as to fix the structures.

When disposing the adhesive agent 27, for example, it is possible to use a method of providing the paste of the adhesive agent 27 in the gap between the front structure 11 and the rear structure 12, and thereafter hardening the adhesive agent 27. At this time, by providing the adhesive agent 27 so as to cover the end portion of either the front structure 11 or the rear structure 12, the front structure 11 and the rear structure 12 can be fixed with the structure shown in FIG. 2.

Further, as another method, it is also possible to use a method of applying the paste of the adhesive agent 27 to the outside of the region to which the vacuum grease 26 is applied in advance, and hardening the adhesive agent 27 after the alignment step. In this case, in order to prevent the adhesive agent 27 from being hardened before the alignment step is finished, a material which is hardened by a heating or a light irradiation is preferably used for the adhesive agent 27.

In the stage of the fixing step, since the discharge space 24 of the PDP 10 is shut off from outside, it is not necessary to consider the contamination of the discharge space 24 in the material selection of the adhesive agent 27. Accordingly, any arbitrary material can be selected within the range capable of obtaining a predetermined adhesive strength.

By appropriately selecting the material of the adhesive agent 27, the heating temperature necessary for the fixing step can be significantly reduced in comparison with the case of using the frit glass as the adhesive agent 27. For example, in the case of using the frit glass, the heating to 400° C. or more corresponding to a softening point is necessary, but hardening can be achieved without heating when the silicone rubber or the like is used. In other words, it is possible to omit the heating step for hardening.

Further, the hardening time can be further shortened by heating the silicone rubber. Also, even in the case of using the thermosetting resin, the thermoplastic resin or the like, the hardening can be achieved with the heating temperature of 200° C. or less. Accordingly, the time for heating a whole of the PDP 10 for fixing the front structure 11 and the rear structure 12 can be significantly shortened.

Further, it goes without saying that a material containing one or more of carbon fiber, glass fiber, metal fiber and the like can be used for these materials in order to secure the strength and the rigidity of the adhesive agent 27 itself.

More specifically, according to the first embodiment, since the material of the adhesive agent 27 can be selected within a range capable of obtaining the predetermined adhesive strength, the heating time necessary for the fixing step can be significantly shortened or omitted. Therefore, the manufacturing efficiency of the PDP 10 can be significantly improved.

Further, since the PDP 10 is sealed with the vacuum grease 26, it is not always necessary to dispose the adhesive agent 27 so as to surround a whole periphery of the vacuum grease 26. For example, as shown in FIG. 3, the vacuum grease 26 may be partly exposed. Since the manufacturing process can be simplified when such a structure is employed, the manufacturing efficiency can be improved.

However, from the viewpoint of dispersing the force applied to the PDP 10 in the conveyance of the PDP 10 during the manufacturing process or after the completion, the adhesive agent 27 is preferably disposed so as to surround the whole periphery of the vacuum grease 26. If the adhesive agent 27 is disposed so as to surround the whole periphery of the vacuum grease 26, the front structure 11 and the rear structure 12 can be fixed more surely. Further, it is possible to disperse an external force applied to the PDP 10 even if the external force is applied to the PDP 10 in the conveyance of the PDP 10 during the manufacturing process or after the completion.

(c4) Next, in a discharge gas introducing step, a predetermined discharge gas is introduced into the discharge space 24 through the ventilation path (not shown) connected to the tip tube 25 shown in FIG. 7. Before the introduction of the discharge gas, the remaining gas in the discharge space 24 is exhausted in advance.

In the first embodiment, the remaining gas in the discharge space 24 is exhausted by using a vacuum pump as exhausting means, and then a mixed gas of Ne and Xe (partial pressure ratio is 85:15) is introduced by using a gas feeding pump at 500 torr (approximately 67 kPa).

(c5) Finally, in a tip-tube sealing step, the opening of the tip tube 25 is sealed and cut, thereby completing the PDP 10 shown in FIGS. 1 to 3.

In the PDP 10 according to the first embodiment, the steps up to the sealing step after forming the protective layer 18 are performed under the vacuum (reduced pressure) atmosphere. Therefore, it is possible to prevent the contamination (adsorption of impurity) of the protective layer 18. Accordingly, it is possible to omit an aging step (step of activating the protective layer 18 by holding it in the discharge state for several hours) after the assembling step (c). In other words, it is possible to improve the manufacturing efficiency.

Further, according to the first embodiment, the heating treatment time in the sealing step and the fixing step can be significantly shortened. Therefore, an in-line process in which a plurality of PDPs 10 are continuously processed can be employed as the manufacturing step of the PDP 10 in place of a batch process in which a plurality of PDPs 10 are intermittently processed.

Therefore, even in the case where a problem (for example, leakage of the discharge gas due to a sealing defect or the like) occurs in a certain PDP 10 due to a trouble during the manufacturing process, it is possible to reduce the influence on the other PDPs 10.

### First Modified Embodiment of the First Embodiment

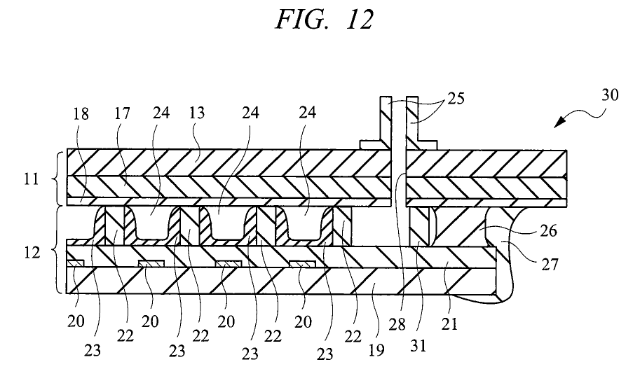

As a first modified embodiment of the first embodiment, the structure as shown in FIG. 12 can be employed. FIG. 12 is an enlarged cross sectional view showing the principal part of a structure of a peripheral portion of a panel structure in which a front structure and a rear structure are combined, in a manufacturing method of a PDP according to the first modified embodiment of the first embodiment.

The difference between the PDP 30 shown in FIG. 12 and the PDP 10 shown in FIG. 7 lies in that a dummy barrier rib (second barrier rib) 31 is disposed between the vacuum grease 26 and the barrier rib (first barrier rib) 22 disposed on an outermost side. As shown in FIG. 12, by forming the dummy barrier rib 31 between the vacuum grease 26 and the barrier rib 22 disposed on the outermost side, it becomes possible to prevent the vacuum grease 26 from entering an inner space of the PDP 30. Further, it is also possible to adjust an interval between the front structure 11 and the rear structure 12 (interval in a thickness direction of the PDP 30) by adjusting the height of the dummy barrier rib 31. In other words, although the dummy barrier rib 31 can be formed in the same manufacturing method as the barrier rib 22, it is not a barrier rib formed for partitioning the discharge space 24 like the barrier rib 22.

### Second Modified Embodiment of the First Embodiment

As a second modified embodiment of the first embodiment, the following manufacturing method can be employed.

More specifically, although the sealing step (c1) has been described as the step performed under the vacuum (reduced pressure) atmosphere, the atmosphere of the PDP 10 shown in FIG. 2 is replaced with the discharge gas conditioned at a predetermined pressure. The discharge gas introducing step (c4) and the sealing step (c5) can be omitted by performing the sealing step under the discharge gas atmosphere conditioned at the predetermined pressure.

Therefore, the number of manufacturing steps can be reduced, and the manufacturing efficiency of the PDP 10 can be further improved.

Incidentally, since it is inevitable that the manufacturing apparatus has a complicated mechanism when the sealing step (c1) is performed after the alignment step (c2), it is necessary to secure an operating space of the complicated mechanism. Therefore, the capacity of the chamber for performing the sealing step becomes large, and there arises a problem that the manufacturing cost is significantly increased when the expensive discharge gas is filled in the chamber.

Further, it is very difficult to perform the alignment step and the sealing step while maintaining the discharge gas within a range of a predetermined pressure and a predetermined purity, and it is difficult to achieve the sealing step under the discharge gas atmosphere.

However, in the first embodiment, the sealing step is performed before the alignment step. Also, since the vacuum grease 26 used as the sealing material can be sealed without heating, it is possible to achieve the sealing with a very simple mechanism.

Since the sealing step can be performed with the simple mechanism, the capacity of the chamber for performing the sealing step can be reduced. In other words, the increase of the manufacturing cost caused by performing the sealing step under the discharge gas atmosphere can be significantly suppressed. Further, it is easy to maintain the discharge gas in the chamber at the predetermined pressure and the predetermined purity.

Therefore, according to the first embodiment, it is possible to achieve the sealing step under the discharge gas atmosphere.

Further, by performing the sealing step under the discharge gas atmosphere, it becomes unnecessary to introduce the discharge gas after sealing. Therefore, the chip tube 25 and the hole portion 28 shown in FIG. 7 are not necessary. Accordingly, in the PDP manufactured according to the present modified embodiment, the through hole (hole portion 28) is formed neither in the front structure 11 nor in the rear structure 12, and the chip tube 25 which is the ventilation member protruding from the surface of the PDP 10 is not formed.

By removing the ventilation member protruding from the surface of the PDP as described above, it becomes possible to prevent a contamination gas from entering the discharge space even when the ventilation member is broken due to the impact applied to the PDP.

### Second Embodiment

In a second embodiment, a structural example in which the PDP 10 described in the first embodiment is incorporated in a plasma display module (hereinafter, referred to as PDP module) or a plasma display apparatus (hereinafter, referred to as PDP apparatus) will be described.

Note that, in the second embodiment, an example of the PDP module 100 and the PDP apparatus 200 in which the PDP 10 is incorporated is described, and the structure other than the PDP 10 described in the first embodiment is not limited to that described in the second embodiment.

In the second embodiment, the PDP module is a module that includes a PDP, a base chassis disposed on a side opposite to a display surface of the PDP and supporting the PDP, and various circuit substrates disposed on a rear surface side of the base chassis (surface opposite to a surface facing the PDP) and driving and controlling the PDP module. Also, the PDP apparatus is a display apparatus obtained by covering the PDP module with an outer casing and fixing the PDP module to a supporting structure such as a stand.

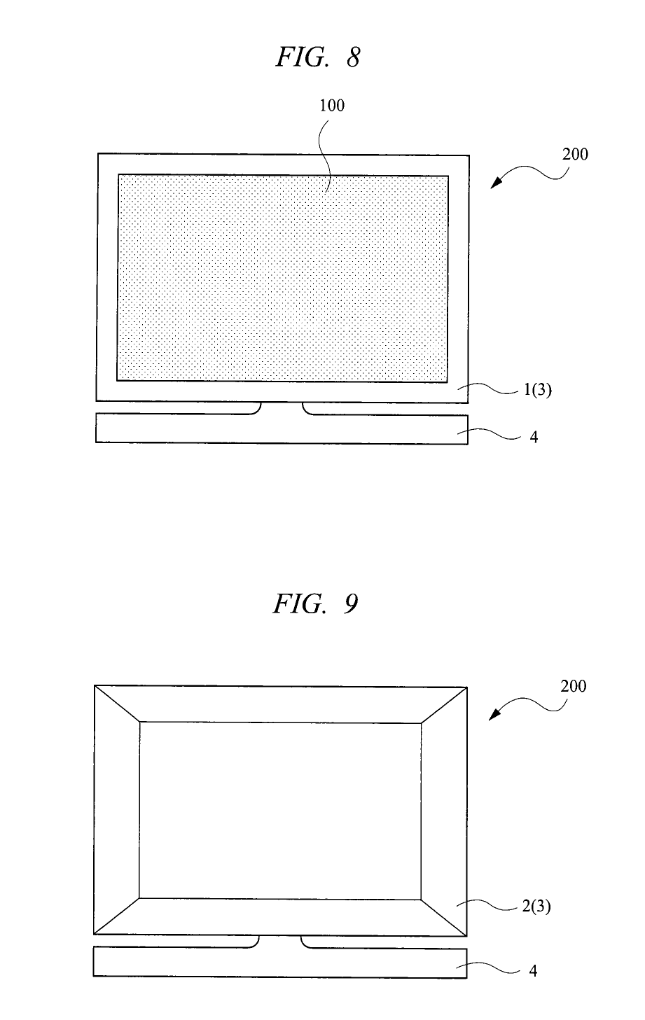

FIG. 8 is a plan view of the PDP apparatus 200 according to the second embodiment seen from a display surface side. FIG. 9 is a plan view of the PDP apparatus 200 shown in FIG. 8 seen from a rear surface side. FIG. 10 is a plan view showing the state where a front frame cover 1 is removed from the PDP apparatus 200 shown in FIG. 8.

In FIG. 8 and FIG. 9, the PDP apparatus 200 according to the second embodiment has the PDP module 100. Also, the PDP apparatus 200 is provided with an outer casing 3 accommodating this PDP module 100 and composed of the front frame cover 1 and a rear cover 2.

Also, the PDP apparatus 200 is provided with a stand (external supporting structure) 4, which is an external supporting structure, and the PDP module 100 is supported by the stand 4.

Furthermore, as shown in FIG. 10, the PDP 10 described in the first embodiment is fixed on the display surface side of the PDP module 100. The PDP 10 is fixed so that the front structure 11 is disposed on the display surface side.

Still further, the lengths of outer margins of the front structure 11 and the rear structure 12 forming the PDP 10 are different from each other, and the front structure 11 and the rear structure 12 are laminated in a state where one of them partly protrudes from the other. Still further, at a corner portion of the region where the front structure 11 and the rear structure 12 are laminated in a state of being opposed to each other, the tip tube 25 described in the first embodiment is disposed with its opening being sealed.

Furthermore, the rear structure 12 side of the PDP 10 is fixed to a base chassis 60. As fixing means for fixing the PDP 10 to the base chassis 60, for example, an adhesive layer such as a double-faced tape is used so as to tightly fix them.

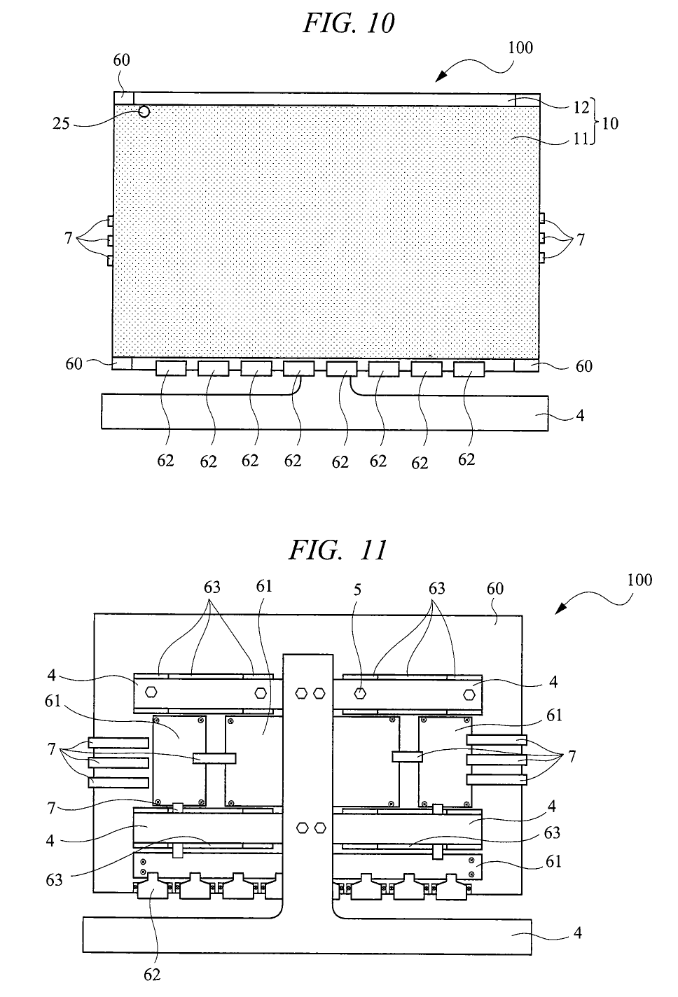

Next, the structure of a rear side of the PDP module will be described with reference to FIG. 11. FIG. 11 is a plan view showing the state where the rear cover 2 is removed from the PDP apparatus 200 shown in FIG. 9.

In FIG. 11, a plurality of mounting members 63 for fixing the base chassis 60 to the stand 4 which is an external supporting structure are fixed to this base chassis 60.

The PDP module 100 is supported by fixing the mounting members 63 fixed to the base chassis 60 to the stand 4.

As means for fixing the mounting members 63 to the stand 4, fixing means capable of strong fixing is appropriately selected because it has to support the PDP module 100 of heavy weight. For example, through holes are formed in a part of the stand 4 and the mounting members 63, and bolts 5 and nuts (not shown) are used for fixing.

Next, circuits for driving and controlling the PDP module 100 will be described. As shown in FIG. 11, the PDP module 100 is provided with a plurality of circuit substrates 61. Each of the circuit substrates 61 is fixed to the base chassis 60 by screws, for example.

Examples of the circuits of the PDP module 100 include an X drive circuit for applying a voltage to the X electrodes 14 (refer to FIG. 1) of the PDP 10, a Y drive circuit for applying a voltage to the Y electrodes 15 (refer to FIG. 1) thereof, an address drive circuit (address relay circuit) and address driver modules (ADMs) 62 for applying a voltage to the address electrodes 20 (refer to FIG. 1) thereof, a power supply circuit that supplies power to each component, and a control circuit that controls the entire module including the respective components.

In the PDP module 100, these circuits are formed on the plurality of circuit substrates 61. Which circuit substrate on which these circuits are to be formed can be appropriately changed depending on the layout and the driving method of the PDP module.

Also, in the second embodiment, the PDP module 100 is provided with eight ADMs 62, and each of the ADMs 62 has one end electrically connected to the address drive circuit. As shown in FIG. 11, the ADMs 62 extend around the outside of the edge portion of the base chassis 60 to the side of the PDP 10 (refer to FIG. 10), and the other end of each ADM 62 is electrically connected to a terminal of the address electrode 20 shown in FIG. 1.

In the second embodiment, the address drive circuit and the ADMs 62 are disposed in a lower-side portion of the PDP module 100. However, other structures such as that the address drive circuit and the ADMs 62 are disposed in both upper and lower side portions are also applicable depending on the driving method and others.

Furthermore, other circuit substrates 61 are also connected to the terminals of the PDP 10 via wires 7. As these wires 7, flexible substrates such as the ADMs 62, band-shaped deformable wires called flat cables and others can be used. Still further, the circuit substrates 61 are electrically connected to each other via the wires 7.

By incorporating the PDPs 10 and 30 described in the first embodiment in the PDP module 100 or the PDP apparatus 200 described in the second embodiment, the PDP module 100 or the PDP apparatus 200 capable of reducing power consumption at the time of driving can be obtained.

In the foregoing, the invention made by the inventor of the present invention has been concretely described based on the embodiments. However, it is needless to say that the present invention is not limited to the foregoing embodiments and various modifications and alterations can be made within the scope of the present invention.

For example, although the PDP in which the hole portion 28 and the chip tube 25 shown in FIG. 7 are not formed has been described as a modified embodiment of the first embodiment, it goes without saying that this PDP can be incorporated in the PDP module 100 or the PDP apparatus 200 described in the second embodiment.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A plasma display panel comprising a first structure and a second structure which are disposed so as to be opposed to each other,
wherein the first structure comprises:
a first substrate;
a plurality of first electrodes formed on a surface of the first substrate, the surface facing the second structure; and
a first dielectric layer covering the first electrodes,
the second structure comprises:
a second substrate;
a plurality of second electrodes formed on a surface of the second substrate, the surface facing the first structure; and
a plurality of barrier ribs formed on the surface of the second substrate to partition a discharge space, the surface facing the first structure,
the first structure and the second structure are sealed with a sealing material disposed so as to surround the plurality of barrier ribs and having a gas barrier characteristic, and
the first structure and the second structure are fixed with an adhesive agent disposed on an outer side of the sealing material and having lower viscosity than the sealing material.

2. The plasma display panel according to claim 1,
wherein the sealing material is vacuum grease.

3. The plasma display panel according to claim 2,
wherein the adhesive agent is disposed so as to cover a part of an end portion of the first structure or the second structure.

4. The plasma display panel according to claim 2,
wherein the adhesive agent is made of a material which is hardened by heating of 200° C. or less.

5. The plasma display panel according to claim 1,
wherein a ventilation member is not formed in the plasma display panel.

6. A manufacturing method of a plasma display panel comprising the steps of:
(a) preparing a first structure in which a plurality of first electrodes are formed on one surface of a first substrate and a dielectric layer covering the first electrodes is formed, and a second structure in which a plurality of second electrodes and a plurality of barrier ribs are formed on one surface of a second substrate;
(b) forming a metal oxide layer on a surface of the dielectric layer of the first structure under a reduced pressure atmosphere; and
(c) assembling the first structure and the second structure,
wherein the step (c) comprises:
a sealing step of sealing the first structure and the second structure in a state where the surface of the first structure on which the metal oxide layer is formed and the surface of the second structure on which the barrier ribs are formed are opposed to each other, with a sealing material disposed so as to surround the plurality of barrier ribs;
an alignment step of aligning the first structure and the second structure so as to have a predetermined positional relation; and
a fixing step of fixing the first structure and the second structure with an adhesive agent disposed on an outer side of the sealing material with respect to the barrier ribs, and
the alignment step and the fixing step are performed after the sealing step.

7. The manufacturing method of a plasma display panel according to claim 6,
wherein, in the fixing step, the first structure and the second structure are fixed by hardening the adhesive agent, and the adhesive agent after being hardened has a lower viscosity than the sealing material.

8. The manufacturing method of a plasma display panel according to claim 7,
wherein the sealing step is performed under a reduced pressure atmosphere, and
the alignment step is performed under an ambient atmosphere.

9. The manufacturing method of a plasma display panel according to the claim 7,
wherein, in the fixing step, the adhesive agent is hardened by heating the adhesive agent at a heating temperature of 200° C. or less.

10. The manufacturing method of a plasma display panel according to claim 6,
wherein the sealing step is performed under a discharge gas atmosphere.
